(19) United States
(12) Patent Application Publication
(10) Pub. No.: US 2005/0171834 A1
(43) Pub. Date: Aug. 4, 2005

(54) Work status prediction apparatus, method of predicting work status, and work status prediction program

(75) Inventors: Takeshi Yokota, Tokyo (JP); Shigeru Hasegawa, Tokyo (JP); Makoto Kudoh, Tokyo (JP); Kiyoshi Shimoda, Tokyo (JP)

Correspondence Address: HOGAN & HARTSON L.L.P., 500 S. GRAND AVENUE, SUITE 1900, LOS ANGELES, CA, 90071-2611, US

(73) Assignees: Hitachi, Ltd.; Hitachi Plant Engineering & Construction Co., Ltd.

(21) Appl. No.: 11/046,513

(22) Filed: Jan. 28, 2005

(30) Foreign Application Priority Data
Jan. 30, 2004 (JP) 2004-022484
Sep. 16, 2004 (JP) 2004-269740

(51) Int. Cl. G06F 17/60

(52) U.S. Cl. 705/10

(57) ABSTRACT

To predict a future work status, a variation amount in working efficiency set according to progress of a work regarding the workload and a variation amount in a work resource are considered, and the working efficiency is compensated according compensation of a work resource amount. Data of variation patterns of the working efficiency and the number of workers are previously defined and stored. A variation pattern for each work is selected from the variation pattern data on the basis of a work schedule data stored in the work schedule data storing section. Variation of the workload resource, the workload, and the working efficiency are stored. The prediction result is displayed. Upon excess and lack in the prediction workload over the scheduled workload in a period may be transferred from that period to the next period and from the next to that period, respectively.

### FIELD OF THE INVENTION

The present invention relates to a work status prediction apparatus, a method, and a work status prediction program, for predicting a future work status to provide estimation for work.

### BACKGROUND OF THE INVENTION

Conventionally, to estimate progress of various types of work, methods for predicting future work statuses are frequently used. In the method, values of actual result working efficiency (generally, a ratio of an amount of resource to a workload (an amount of work for a predetermined period)) based on an actual result of the work up to date or scheduled working efficiency defined at a scheduling stage are used as reference. Further, to reflect learning effect of workers, a prediction value of the working efficiency may be varied as a function defined on time.

The prediction methods as described above are frequently applied to work in production lines. As an example, Japanese laid-open patent application publication No. 2000-176799 discloses, at paragraphs 0010 to 0012, a production/manufacture scheduling system and Japanese laid-open patent application publication No. 2002-23823 discloses, at paragraphs 0017 to 0018, a production managing system. Further, Trett Consulting Japan Limited disclosed at a seminar held by the Overseas Construction Association of Japan, Inc., “Good and Bad claims”, part 2-15.45 to 16.35, (2002), in which a relation between the number of workers, which is one of factors of the work resource included in the resource, and the working efficiency is analyzed on the basis of actual cases.

In the conventional technologies mentioned above, values of the future working efficiency based on the actual result values or scheduled values are used as constant values as used at an initial stage. However, an actual work may encounter such a phenomenon that, for example, at an initial stage of the work, the working efficiency is low because the worker has not been experienced yet, but as the work has been done, the working efficiency gradually increases, and then, becomes stable. When the remainder of the work becomes little, the working efficiency decreases again because the worker should take time off for procedures at the finish of the work. In other words, the working efficiency frequently varies as time passes.

To solve this problem, a further process may be added to gradually increase the working efficiency as time passes. However, in this method, variation of the working efficiency as time passes does not always agree with the actual working efficiency. Further, this does not reflect the decrease in the working efficiency when the remainder of the work becomes little.

Further, in the conventional method, an amount of resource for the work (work resource amount), e.g., the number of workers, is estimated as the value is scheduled. Actually, the progress of the work may lag behind the scheduled value, which is problematic if the working efficiency is unchanged.

Further, though the work resource amount is increased, the working efficiency does not always increase in proportion to increase in the work resource amount. More specifically, the working efficiency may decrease due to congestion at worker's space caused by increase in the number of workers or due to increase in the number of inexperienced workers.

### SUMMARY OF THE INVENTION

According to an aspect of the present invention, when a future work status of work is predicted, an amount of variation in the working efficiency (generally, defined as a ratio of an amount of resource to a workload for a predetermined period) and an amount of variation in a resource for the work (work resource), caused in accordance with progress of the work, are considered. Further, the working efficiency may be compensated or altered in accordance with compensation of an amount of work resource (work resource amount).

A further aspect of the present invention provides a work status prediction apparatus for predicting a future work status of work, comprising: work schedule data storing means for storing work schedule data indicative of the work to be done for each future predetermine period such that a work schedule for each future predetermined period is stored as the work schedule data; work actual result data storing means for storing work actual result data, indicative of the work that has been done for each past predetermined period such that a work actual result for each past predetermined period is stored as the work actual result data, the work schedule data and the work actual result data and being entered by a user, the future predetermined period being equivalent to the past predetermined period; work status prediction means for effecting prediction such that a prediction workload of the work for each future predetermined period is predicted from at least one of the work schedule and the work actual result and for predicting the future work status, in which the prediction amount of the future work is reflected in the work schedule data; and prediction result display means of displaying the predicted result from the work status prediction means.

In the above described structure, a prediction workload for each predetermined period may be calculated from at least one of the working efficiency and the schedule resource amount compensated in accordance with progress of the work. Further, the initially set work schedule data (for example, a schedule workload) may be reflected in the calculated prediction workload. This increases accuracy in calculation in the work schedule data.

A further aspect of the present invention described above provides a method of predicting a work status and the work status prediction program for predicting a work status.

When a future work status is predicted, a variation amount of the working efficiency and a variation amount of the work resource (work resource amount) are considered. In other words, working efficiency of various types of work can be accurately calculated though delay or moving-up of a work occurs. Further, it is possible to consider the phenomenon that the working efficiency increases at the initial stage and decreases at the final stage of the work. Further, increase in the number of workers upon occurrence of delay of the work process can be considered. Further, the working efficiency can be compensated in accordance with the compensation of the work resource amount.

### BRIEF DESCRIPTION OF THE DRAWINGS

The object and features of the present invention will become more readily apparent from the following detailed description taken in conjunction with the accompanying drawings in which:

FIG. 1 is a block diagram of a work status prediction apparatus according to an embodiment of the present invention;

FIG. 2 illustrates a flow chart of an outline process in the work status prediction apparatus shown in FIG. 1;

FIG. 3 is a table of an example of a data storing format for work schedule data according to the embodiment of the present invention;

FIG. 4 is a table of an example of a data storing format for work actual result data according to the embodiment of the present invention;

FIG. 5 is a table of an example of a data storing format for working efficiency variation definition data according to the embodiment of the present invention;

FIG. 6 is a table of a definition example of variation patterns of the working efficiency according to the embodiment of the present invention;

FIG. 7 is a table of an example of a data storing format for variation definition data of the number of workers according to the embodiment of the present invention;

FIG. 8 illustrates an example of a defining screen image for a variation pattern in the working efficiency according to the embodiment of the present invention;

FIG. 9 illustrates an example of a definition screen image for the variation pattern of the number of workers in the embodiment according to the present invention;

FIG. 10 illustrates an example of a definition screen image for the variation pattern of the working efficiency for compensating a scheduled workload and a schedule resource amount according to the embodiment of the present invention;

FIG. 11 illustrates a flow chart of a process for work status prediction in the embodiment according to the present invention;

FIG. 12 illustrates a flow chart of a process for compensating the number of workers in the embodiment according to the present invention;

FIG. 13 illustrates a flow chart of a process for compensating the working efficiency in the embodiment according to the present invention;

FIG. 14 illustrates a flow chart of a process for adjusting the workload based on a prediction workload in the embodiment according to the present invention;

FIG. 15 is a table of an example of a data storing format for prediction data in the embodiment according to the present invention;

FIG. 16 illustrates an example of a prediction result display screen image in the embodiment according to the present invention;

FIG. 17 illustrates an example of a further prediction result display screen image in the embodiment according to the present invention;

FIG. 18 illustrates an example of a further prediction result display screen image according to the embodiment of the present invention;

FIG. 19 illustrates a flow chart of a variation pattern learning process according to the embodiment of the present invention;

FIG. 20 is a block diagram of an example of hardware for the embodiment of the present invention;

FIG. 21 shows an example of a data storing format for variation definition data of a working efficiency decrease ratio caused in accordance with a ratio of the number of increased workers according to the embodiment of the present invention;

FIG. 22 illustrates an example of a definition screen image for defining a variation pattern regarding a working efficiency decrease ratio caused in accordance with a ratio of the number of increased workers in the embodiment according to the present invention;

FIG. 23 illustrates a flow chart of a compensation process for working efficiency decrease caused in accordance with a ratio of the number of increased workers in the embodiment according to the present invention;

FIG. 24 illustrates an example of a display-and-setting screen image of information regarding compensating the number of workers in the embodiment according to the present invention; and

FIG. 25 illustrates a flow chart of a learning process for the variation patterns of the working efficiency decreases caused in accordance with a ratio of the number of increased workers in the embodiment according to the present invention.

The same or corresponding elements or parts are designated with like references throughout the drawings.

### DETAILED DESCRIPTION OF THE INVENTION

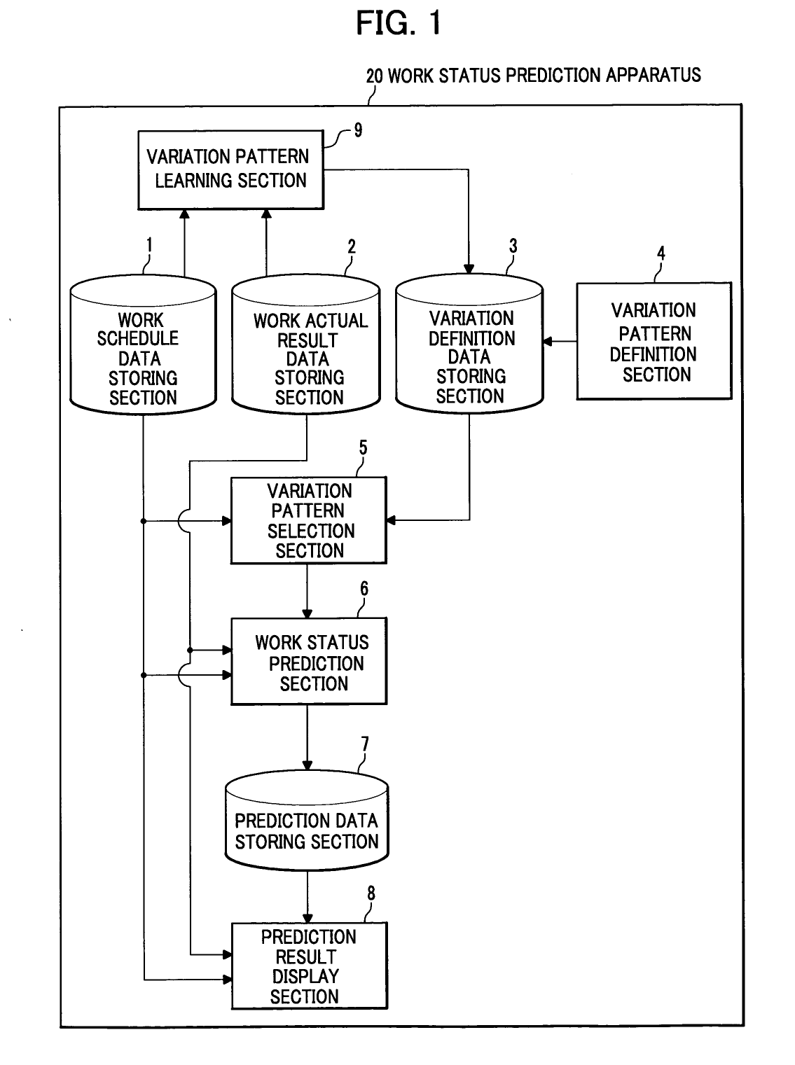

FIG. 1 illustrates a work status prediction apparatus 20 according to the present invention. This embodiment is described with assumption that work is that for construction. The work includes a process, processes, and a project including sequential processes. The working efficiency is generally defined as a ratio of an amount of resource for the work to a workload. A work status prediction apparatus 20 comprises a work schedule data storing section 1, a work actual result data storing section 2, a variation definition data storing section 3, a variation pattern definition section 4, a variation pattern selection section 5, a work status prediction section 6, a prediction data storing section 7, a prediction result display section 8, and a variation pattern learning section 9.

The work status prediction apparatus predicts a future work status of work. Work schedule data is data of a schedule indicating the work to be processed for each future predetermine period and is entered by a user, wherein the schedule data is stored such that a work schedule for each future predetermined period is stored as the work schedule data. Work actual result data is data of actual results indicating the work that has been processed for each past predetermined period and is entered by the user, wherein the actual result data is stored such that a work actual result for each past predetermined period is stored as the work actual result data. The future predetermined period is equivalent to the past predetermined period. The prediction is made such that a prediction workload of the work for each future predetermined period is predicted from at least one of the work schedule and the work actual result to predict the future work status, in which the prediction amount of the future work is reflected in the work schedule data. The predicted result is displayed and provided to the user.

When a future work status is predicted, the user is requested to previously define variation patterns of the working efficiency and the number of workers (head count) with the variation pattern definition section 4 to store the data for definition in the variation definition data storing section 3. Next, the variation pattern selection section 5 selects one of variation patterns used for each work from the variation patterns of the working efficiency and the number of workers stored in the variation definition data storing section 3. The work status prediction section 6 compensates the working efficiency and the number of workers in accordance with the current progress of the work with the data of the work schedule data and the variation patterns. Further the work status prediction section 6 predicts future time-series variation in an amount of the work resource (work resource amount), a workload (an amount of work), and working efficiency with the data. Further, the prediction result display section 8 displays schedule data, actual result data, prediction data with respect to the work resource amount, the workload, and the working efficiency on the basis of the data from the prediction data storing section 7 in a form of a table or a graphical diagram.

Further, the work actual result data storing section 2 stores actual result data of other past work classified in accordance with each type of the work in addition to the actual result data of the work to be currently estimated. The variation pattern learning section 9 updates parameters defining variation patterns for each type of the works at each predetermined period using the past actuarial result data. The updated actual result data is stored in the variation definition data storing section 3.

The work status prediction apparatus 20 is provided by employing a personal computer (PC) or a file server. The work schedule data storing section 1, the work actual result data storing section 2, the variation definition data storing section 3, and the prediction data storing section 7 are provided by employing a non-volatile storage such as a hard disc drive and a flash memory.

The variation pattern definition section 4 is provided by employing a display, a keyboard, a mouse or the like. The prediction result display section 8 is provided by employing the display. Further, the variation pattern selection section 5, the work status prediction section 6, and the variation pattern learning section 9 are provided by execution of predetermined programs stored in a memory by a central processing unit in the PC.

Outline of Process

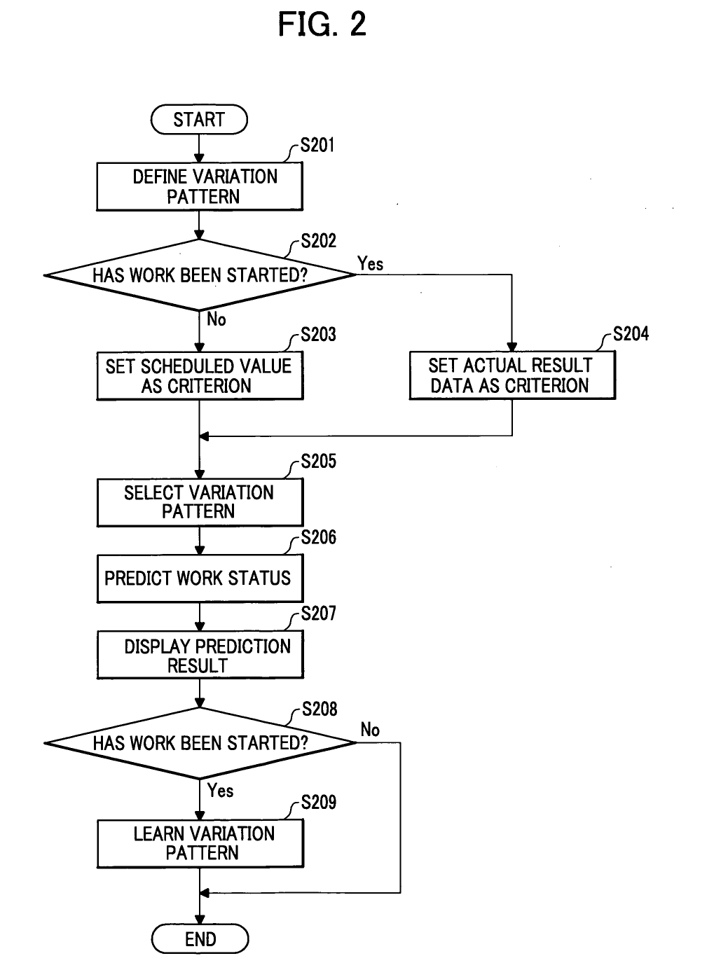

FIG. 2 illustrates a flow chart of an outline of a process in the work status prediction apparatus. The variation pattern definition is executed in a processing step S201. More specifically, the user corrects the parameter previously defined as a default value indicative of how the working efficiency or the number of workers for each work varies in accordance with the progress of the work.

In a judging step S202, it is judged whether the work to be estimated has been started. This is judged by checking whether the work actual result data is stored in the work actual result data storing section 2. If the work has not been started (No, in the judging step S202), processing proceeds to a processing step S203. If the work has been started (Yes, in the judging step S202), processing proceeds to a processing step S204. In the processing step S203, the variation pattern selection section 5 adopts scheduled values as reference. More specifically, a value of a scheduled working efficiency is set as a reference value of the working efficiency used in work status prediction. In the processing step S204, the variation pattern selection section 5 selects actual result values. More specifically, a value of actual result working efficiency calculated from an amount of actual result resource (actual result resource amount) and an amount of actual result work (actual result workload) as a reference value for the working efficiency used upon prediction of a work status. In a processing step S205, the variation pattern selection section 5 selects one of variation patterns used in accordance with the type of the work to be predicted, and the type of the part subject to the work carried out, and the scheduled number of workers.

In a processing step S206, the work prediction is executed. More specifically, using the progress of the work and the data stored in the variation definition data storing section 3, values of the prediction working efficiency and the prediction number of workers which are used to estimate a future work status for each week are compensated. Then, values of a prediction workload (prediction workload) and a prediction amount of resource (prediction resource amount) for each week are calculated. On the basis of the data of the compensated values and the data stored in the work schedule data storing section 1, the prediction workload, and the prediction resource amount for each weak are calculated. This process continues until a prospect for completion of the work is provided (until an amount of remaining work becomes zero).

In a processing step S207, the result (prediction result) calculated in the processing step S206 is displayed as numerical data in a table or as a graph for the user. In a judging step S208, it is judged whether the work to be estimated has been started. If the work has not been started (No, in the step S208), the whole of the process is completed. If the work to be estimated has been started (Yes, in the step S208), processing proceeds to a processing step S209. In the processing step S209, variation pattern learning is done. More specifically, the parameters defining the variation patterns of the working efficiency and the number of workers are updated.

Here, “week” corresponds to terms of “a predetermined period” in claims of the specification.

Example of Data Previously Determined

The work status prediction apparatus of the present embodiment will be further described with an example.

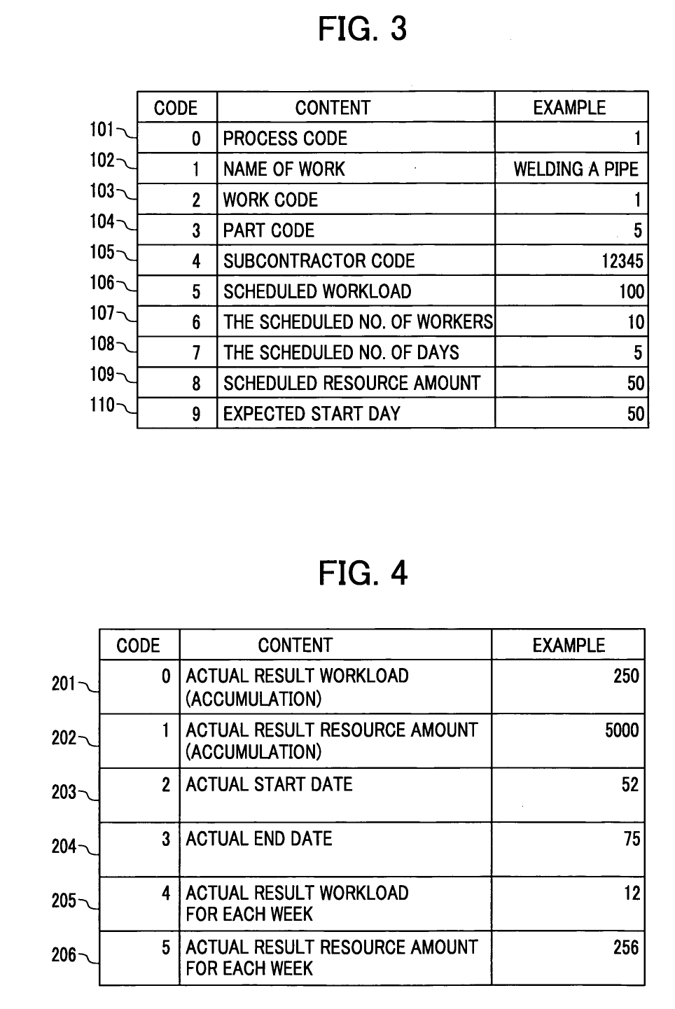

FIG. 3 shows an example of schedule data stored in the work schedule data storing section 1. Items to be stored include a work code (process code) 101 for identifying the work, a work name 102 which is a name of the work to be executed, a work code 103 which is a code for identifying the type of the work, a part code 104 which is a code for identifying the type of the part to be subject to the work, and a subcontractor code 105 which is a code for identifying the subcontractor who actually executes the work. The items further include a scheduled amount 106 of the work (scheduled workload 106), the scheduled number of workers in the work, the scheduled number of days 108 necessary for the work, a scheduled amount of resource (scheduled resource amount) 109 for the work (process), and a scheduled start day 110 of the work (process). The work resource amount can be calculated by multiplying the number of workers by the number of days (man-days). The schedule data is entered by the user.

FIG. 4 shows an example of the actual result data stored in the work actual result data storing section 2. The specific stored data is an actual result workload 201 that is an accumulated value of the workload that has been processed up to date, an actual start date 203 of the work, an actual result end day 204 of the work, an actual result workload 205 for each week, and an actual result resource amount 206 for each week.

If the work to be done has not been started, the actual start day 203 and the actual end date 204 are not stored. If the prediction object of work has not been completed, the actual end date 204 is not stored. Furthermore, the actual result workload 205 for each week and the actual resource amount 206 for each week are stored for all weeks on which actual results exist. Further, in the work actual result data storing section 2, all of actual result data of work executed in the past is left as it is in the similar format. Here, the actual result data is entered by the user or the data for process management that has been stored can be used as the actual result data.

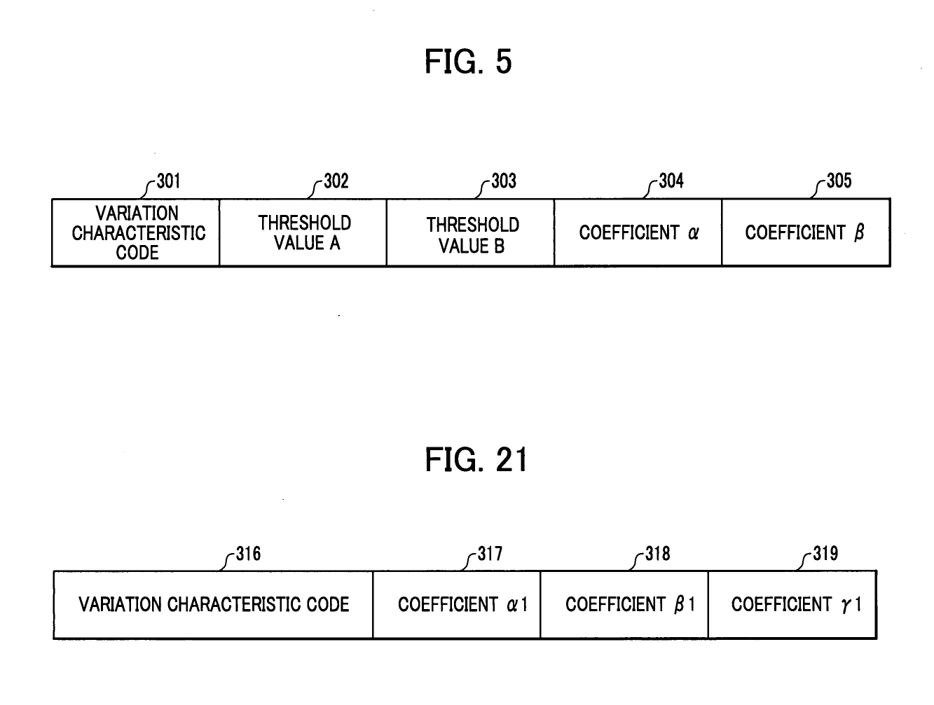

FIG. 5 shows an example of the variation definition data for the working efficiency that is one of data pieces stored in the variation definition data storing section 3. The specifically stored items are a variation characteristic code 301 that is a code for identifying the variation definition data of the working efficiency, a threshold value A 302 indicative of an progress of the work regarding the workload defining timing when it enters a period in which the working efficiency becomes constant, a threshold value B 303 indicative of an progress that defines a timing when the working efficiency begins to gradually decrease just before the completion of the work, a coefficient α 304 defining an improved ratio of the working efficiency for each week on which the working efficiency is gradually improved, and a coefficient β 305 defining a degradation ratio of the working efficiency for each week on which the working efficiency becomes gradually decreased.

The variation characteristic code 301 of the working efficiency is previously defined and associated, on the basis of a basic data stored in the variation definition data storing section 3, with the type of the work of which work status is predicted and with the type of the part to be used in the work.

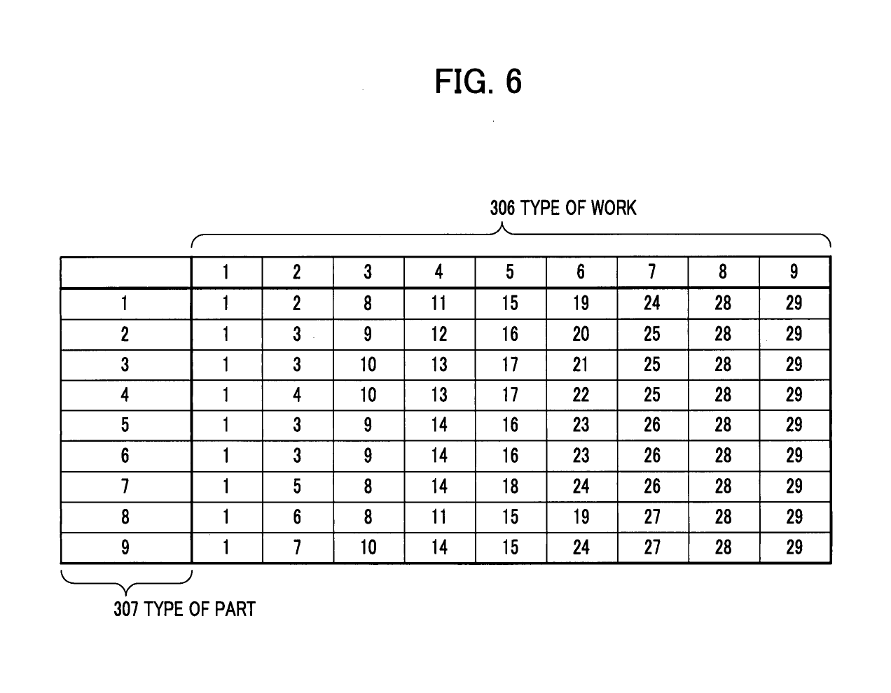

FIG. 6 shows an example of definition of the variation patterns corresponding to the types of work and the types of the parts in a table in which the uppermost line represents types 306 of work (corresponding to the work code 103 in FIG. 3), and the leftmost column represents the types 307 of parts (corresponding to the part code 104 in FIG. 3). The values set in the matrix correspond to the variation characteristic code 301.

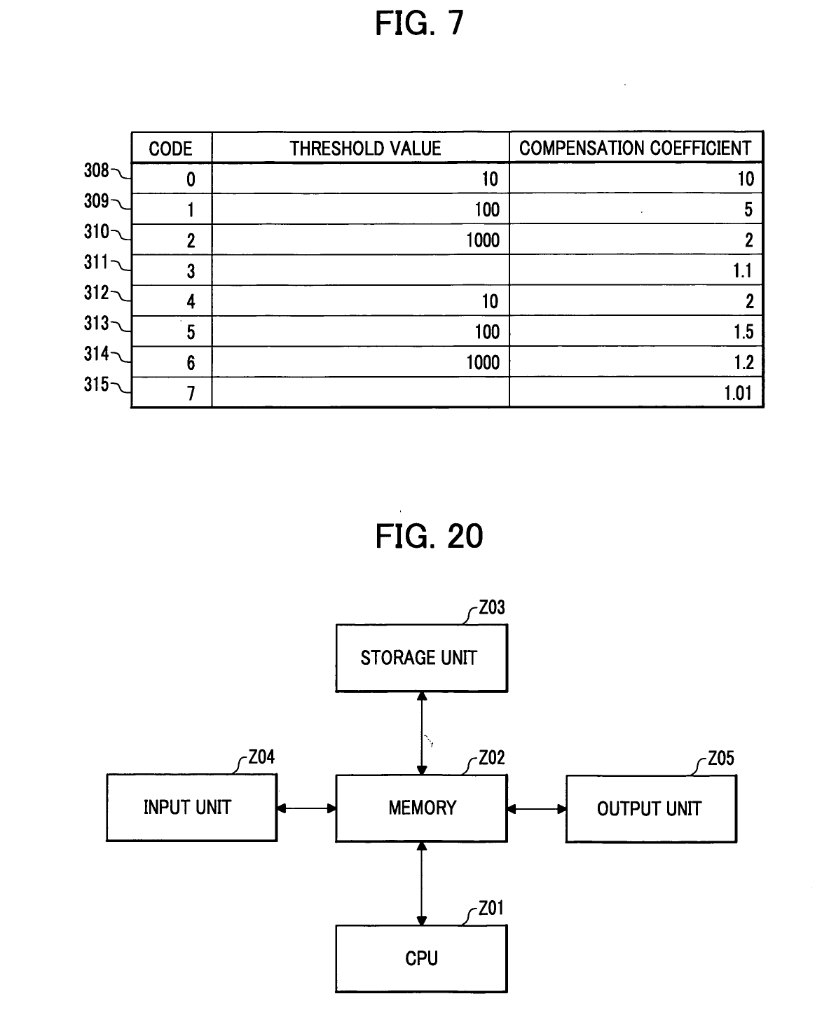

FIG. 7 shows an example of the variation definition data of the number of workers that is one piece of data stored in the variation definition data storing section 3. The data defines a compensation coefficient for increasing the scheduled number of workers for the next week when a ratio of a delay amount, i.e., a difference, of accumulated actual result workload from an accumulated scheduled workload up to date to the total workload exceeds a predetermined value. Further, the compensation coefficient has a different value depending on whether the next week at this moment is within a period of construction (within a period of construction, in other words, there is data of the scheduled number of workers for each week) or beyond the period of construction (the past of the scheduled period of construction, in other words, there is no data of the scheduled number of workers for each week).

Regarding the case that the next week is within the period of construction, when the scheduled number of workers is from one to the threshold value defined in the row 308, a compensation coefficient for the number of workers is shown at a row 308. When the scheduled number of workers is from the threshold value at the row 308 plus one to the threshold value defined in a row 309, a compensation coefficient is shown at a row 309. When the scheduled number of workers is from the threshold value at the row 309 plus one to the threshold value defined in the row 310, a compensation coefficient is shown at a row 310. When the scheduled number of workers is from the threshold value at the row 310 plus one to the threshold value defined in the row 311, a compensation coefficient is shown at a row 311.

Regarding the case that the next week is beyond the period of construction, when the scheduled number of workers is from one to the threshold value defined in the row 312, a compensation coefficient is shown at a row 312. When the scheduled number of workers is from the threshold value at the row 312 plus one to the threshold value defined in the row 313a compensation coefficient is shown at a row 313. When the scheduled number of workers is from the threshold value at the row 313 plus one to the threshold value defined in the row 314, compensation coefficient is shown at a row 314. When the scheduled number of workers is more than the threshold value at the row 314, a compensation coefficient is shown at a row 315. The code at the leftmost column is an identification code for identifying each definition data.

FIG. 21 shows an example of the variation definition data of the working efficiency accompanied with the compensation of the scheduled resource amount that is one piece of data stored in the variation definition data storing section 3.

The data includes a coefficient parameters for defining a function for obtaining a working efficiency decrease ratio corresponding to the ratio of the number of increased workers (the number of workers after compensation/the scheduled number of workers) for each variation characteristic code 316 (301 in FIG. 6) of the working efficiency defined in FIG. 6. The coefficient parameters include three parameters, namely, a coefficient α1 317, a coefficient β1 318, and a coefficient γ1 319.

The work status prediction section 6 calculates the working efficiency decrease ratio with the function represented in Equation (1) using these parameters.
(Working efficiency Decrees Ratio)=α1 LN((Ratio of the Number of Increased Workers)×γ1)+β1 (1)
where LN (*) defines a natural logarithm.
Example of Screen Image for Defining Variation Pattern

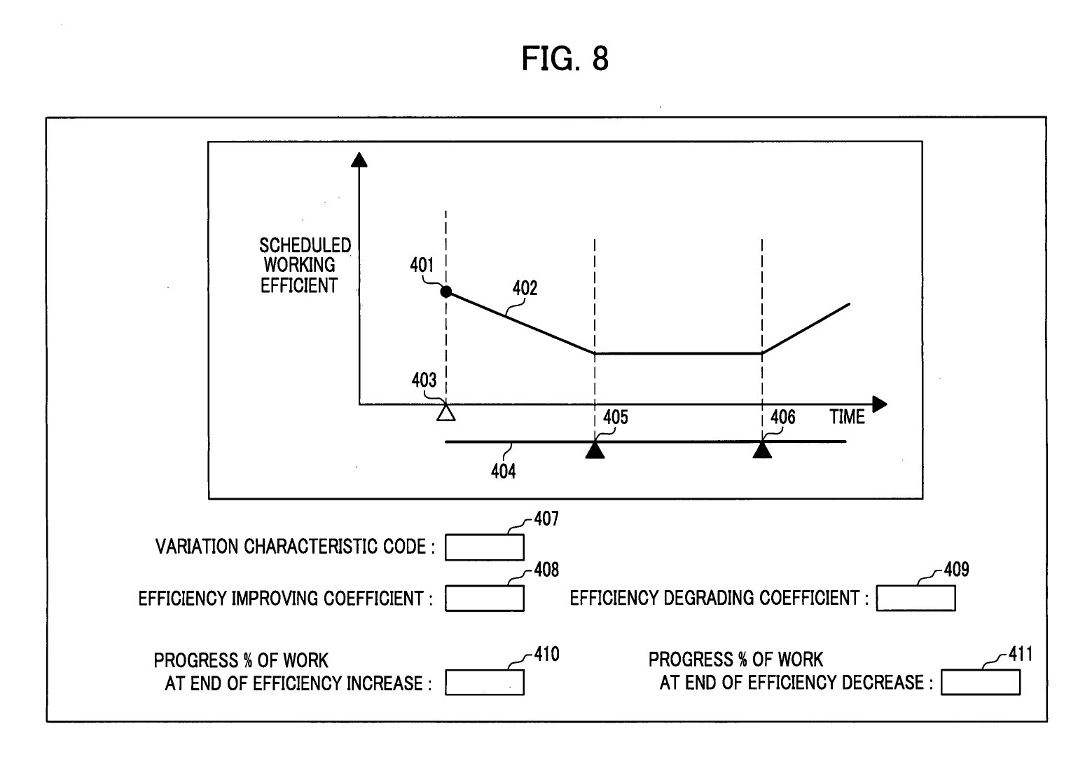

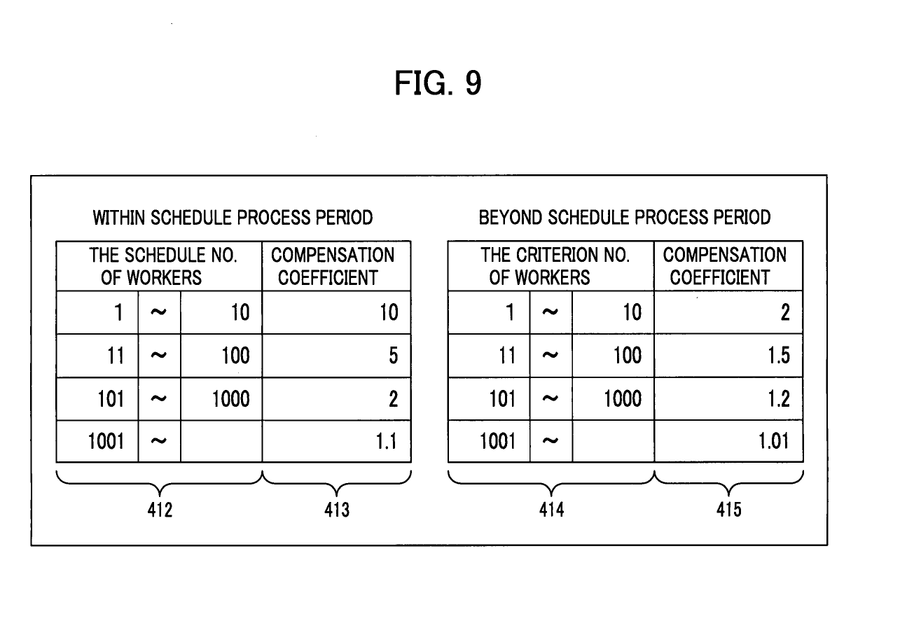

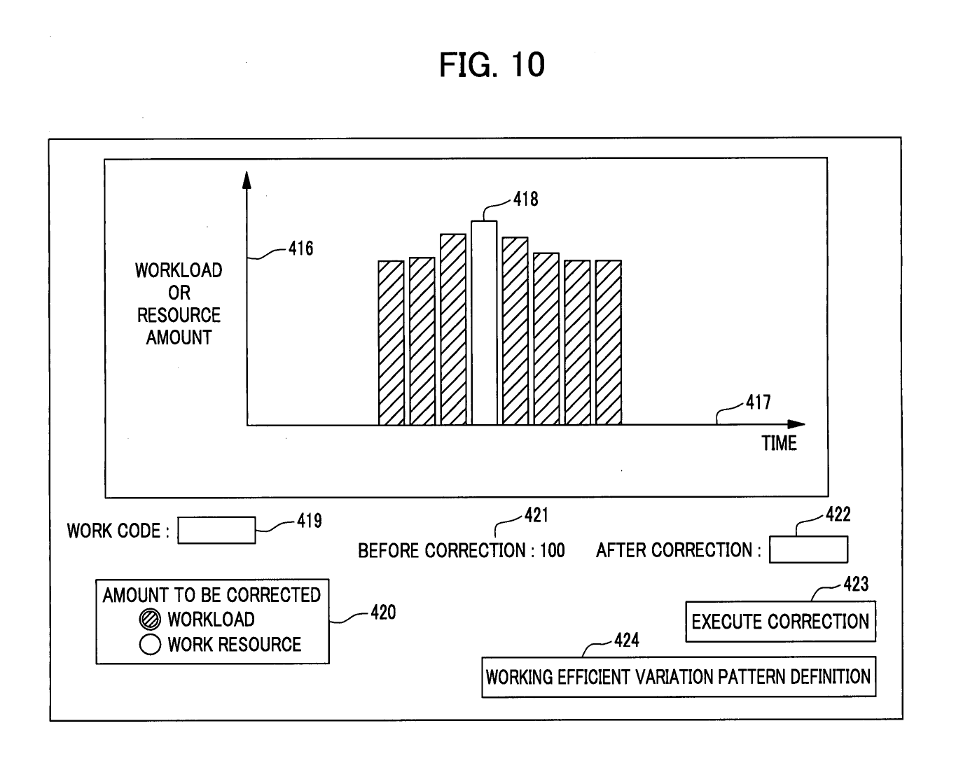

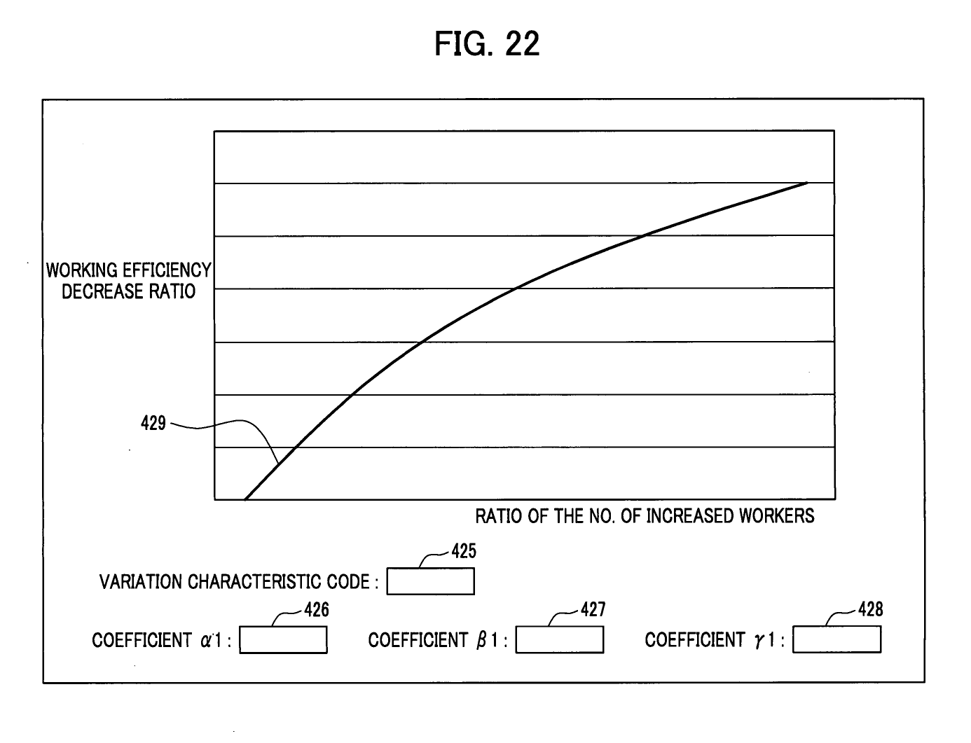

FIGS. 8, 9, 10 show examples of screen images for the variation pattern defining section 4. FIG. 8 shows a screen image for defining the variation pattern of the working efficiency. FIG. 9 shows a screen image for defining the variation pattern of the number of workers. FIG. 10 shows a screen image for defining the variation pattern of the working efficiency after the compensation of the scheduled resource amount. FIG. 22 shows a screen image for defining the variation pattern of the working efficiency accompanied with the compensation of the scheduled resource amount.

On the definition screen image of the variation pattern of the working efficiency in FIG. 8, data of the variation pattern corresponding to the variation characteristic code entered at the variation characteristic code input area 407 is displayed by a graphical diagram or numerical indication. The axis of abscissa represents time, and the axis of ordinate represents the scheduled working efficiency. The graph indicates a value 401 of the scheduled working efficiency calculated from a scheduled resource amount 109 and the scheduled workload 106, of the work (see FIG. 3) with the Equation (2), and a curve 402 indicative of how the scheduled operation efficiency varies in accordance with the variation pattern. The graphical diagram further indicates the scheduled start date 403 of the work and a curve 404 indicative of the progress of the work regarding the workload. The graphical diagram still further indicates a point 405 indicating, on the progress of the work regarding the workload, timing when it shifts from the period for which the scheduled working efficiency gradually increases to the period for which the scheduled working efficiency becomes unchanged and a point 406 indicating, on the progress of the work regarding the workload, timing when it shifts from the period for which the scheduled working efficiency is constant to the period for which the scheduled working efficiency gradually decrease. Here, according to the Equation (2), the higher the working efficiency, the lower the scheduled working efficiency.
(Scheduled Working efficiency)=(Scheduled Resource Amount)/(Scheduled Workload) (2)

Further, the screen image displays a working efficiency improvement coefficient 408 defining the efficiency increase ratio for each week for which the working efficiency gradually increases, and the working efficiency deterioration coefficient 409 defining the efficiency decrease ratio for each week for which the working efficiency gradually decreases. The screen image further displays a progress % 410 of the work regarding the workload corresponding to the point 405 (work progress regarding the workload at saturation of increase in the efficiency), and the work progress % (when the efficiency decreases again) 411. The compensation of the variation pattern is done by correcting the displayed number on the boxes 408 and 411 on the screen image in an interactive manner between the user and the work status prediction apparatus 20.

The variation pattern definition screen image shown in FIG. 9 for the number of workers displays, regarding within the scheduled period of construction, range data 412 which indicates ranges of the scheduled number of workers in the week to be compensated and compensation coefficients 413 corresponding to the range data 412. Regarding beyond the scheduled period of construction, the screen displays data 414 of the range for the criterion number of workers to be compensated (the actual (predicted) number of workers) and compensation coefficients 415 corresponding to the data 414. The compensation of the variation pattern is done by correcting the displayed number on the boxes of the data 412 and 415 on the screen image in the interactive manner. Here, “actual result (prediction)” means “actual result or prediction”.

On the variation pattern definition screen image for the working efficiency shown in FIG. 10, the user selects one of the work codes of the work defining the variation pattern of the working efficiency at a work code input area 419. When the user selects one of the scheduled workload and the scheduled resource amount, of the work code selected by the user with a selection radio button (icon) 420, the selected data is displayed on a graph indicating the scheduled amount for each week. The axis 416 of ordinate of the graph indicates the workload or the resource amount, and the axis 417 of abscissa represents time. Among the bars on the bar graph displayed on the screen, when the user selects the bar of the week subject to correction with the mouse or the keyboard, the color of the selected bar 418 is changed, and the current scheduled value is displayed on a display area 421 before correction. Entering an amount of correction (correction amount) for the scheduled value of the week in a correction amount input area 422 and clicking of a correction execution button (icon) 423 updates the scheduled value of the week to a value after correction. This process is executed for each week regarding the workload and the work resource. When all correction has been completed, clicking of a working efficiency variation pattern definition button (icon) 424 replaces the scheduled workload or the scheduled resource amount of the work at respective weeks with the data corrected on the screen image shown in FIG. 10. Here, it is also possible to correct both the scheduled workload and the scheduled resource amount.

After that, the variation pattern selection section 5 selects from the matrix of data shown in FIG. 6 the variation pattern of the working efficiency specified by the variation characteristic code 301 corresponding to the work code 103 of the work to be estimated and the part code 104 of the part of the work object. Further, from the variation definition data of the number of workers shown in FIG. 7, one of the variation patterns of the number of the workers is selected according to the scheduled number of workers.

On the variation definition pattern definition screen image, in FIG. 22 for defining the working efficiency accompanied with the correction of the scheduled resource amount, first, the user inputs a variation characteristic code 425 defining the variation definition pattern of the working efficiency, and then inputs the coefficient α1 426, the coefficient β1 427, and the coefficient γ1 428, which are coefficient parameters in Equation (1). During this, the relation between the ratio of increase in the number of workers and the ratio of decrease in the working efficiency on a curve 429 displayed on the basis of the information of the inputted coefficient parameters, which promotes understanding by the user regarding correlation therebetween.

Prediction Process of Work Status

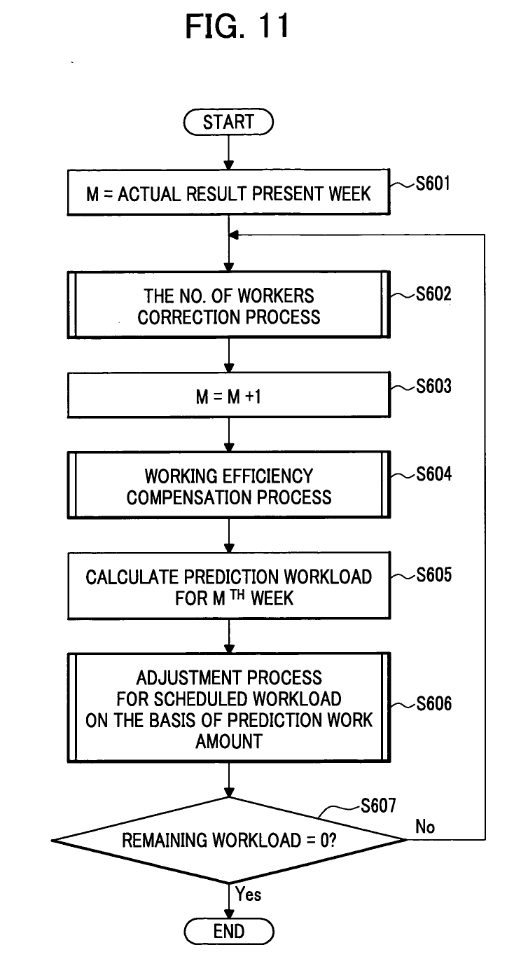

FIG. 11 illustrates a flow of the prediction process of the work status. This process is executed by the work status prediction section 6. Regarding the outline of the process, the prediction workload is calculated for each week, and the scheduled workloads initially set are adjusted in accordance with the calculated prediction workloads to increase the accuracy. Here, the scheduled workload for each week is varied in accordance with this process. However, the total of the scheduled workload is unchanged.

First, in step S601, a value indicative of the actual result present week is set to a variable M indicative of the present week to be estimated. Here, the actual result present week means the final week of the actual result data stored in the work actual result data storing section 2. For example, if today is an intermediate day of this week, the actual final week is the last week. In a subroutine step S602, the compensation process is executed for the scheduled number of workers on (M+1)^{th} week on the basis of the data selected by the variation pattern selection section 5. In a processing step S603, one is added to the value in the variation M. In a subroutine step S604, a compensation process of the prediction working efficiency on M^{th} week is executed. In a processing step S605, the prediction workload is calculated with Equation (3) using the scheduled number of workers calculated in the subroutine step S602 and the data of the prediction working efficiency calculated in the step S604.
(Prediction Workload)=(the Scheduled Number of Workers)×(the Number of Days in the M^{th} week)/(Prediction Working efficiency) (3)

In a subroutine step S606, the scheduled workload for the M^{th} week is compared with the value of the prediction workload obtained in step S605 to execute an adjustment process for the scheduled workload for the remaining work. In a judging step S607, it is judged whether the remaining workload of the work is zero or not. If the remaining workload (unfinished workload) is not zero (No, in the judging step S607), processing returns to the subroutine step S602. If remaining workload is zero (Yes, in the judging step S607), processing is completed. The remaining workload is calculated by Equation (4).
(Remaining Workload)=(Scheduled Workload (the whole))−[(Actual Result Workload (accumulation))+(Prediction Workload (accumulation))] (4)

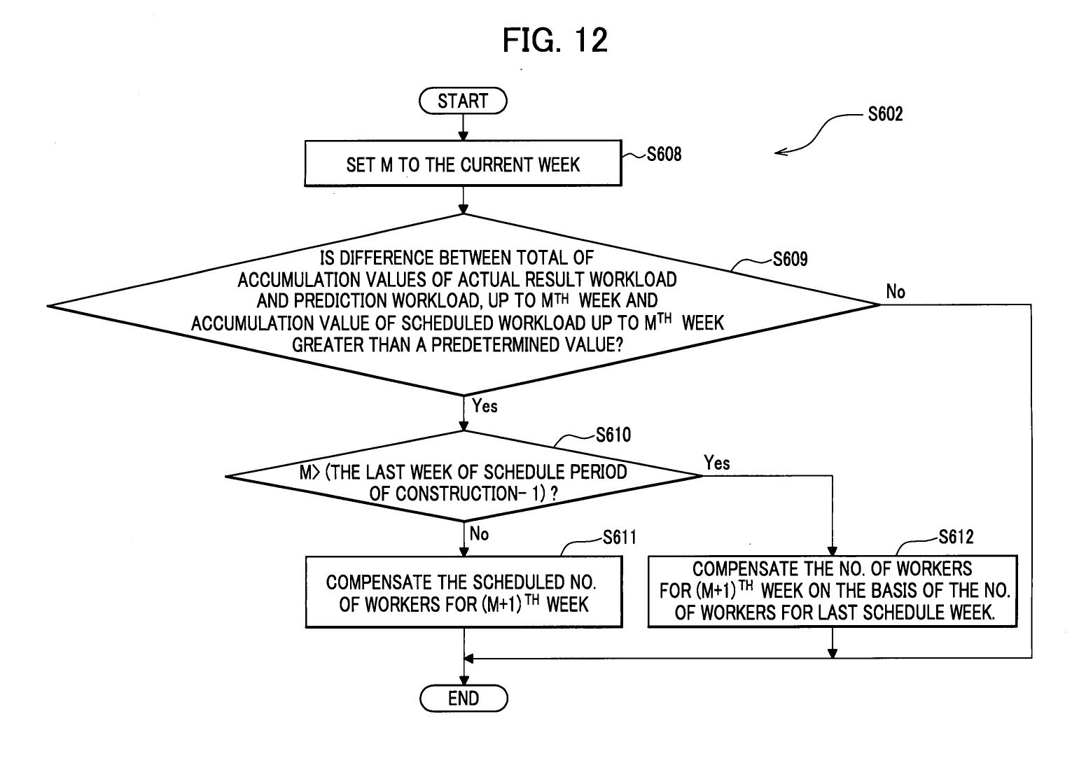

FIG. 12 shows a flow chart of the subroutine S602. In a processing step S608, the variation M is set to the present week (an integer indicating the number of weeks from the start of the work). In a judging step S609, it is judged whether a difference (indicative of delay in the workload) between a total of an accumulation value of actual result workload up to the M^{th} week and an accumulation value of the prediction workload and an accumulation value of the scheduled workload up to the M^{th} week is greater than a predetermined value. If the difference is equal to or greater than the predetermined value, processing proceeds to a judgment step S610. If the difference is not greater than the predetermined value, processing ends in this subroutine S602.

Here, this predetermined value is determined as a value of 10% of the whole of the scheduled workload in order to judge whether the affection of the delay in the workload on the whole of the work is large or not. In the judgment step S610, it is judged whether the variation M is greater than a value which is smaller than the ordinal number of the last week by one. If the variation M is not greater than the value (No, in the judgment step S610), processing proceeds to process in a processing step S611. If the variation M is greater than the value (Yes, in the judging step S610), processing proceeds to a processing step S612. In the processing step S611, the scheduled number of workers for the (M+1)^{th} week is compensated by the following Equation (5).
(The Scheduled Number of Workers for (M+1)^{th} Week)=(the Scheduled Number of Workers for (M+1)^{th} Week)×(Compensation Coefficient) (5)

In the processing step S612, the scheduled number of workers for the (M+1)^{th} week is compensated by compensating the number of workers for the schedule last week as a base with the compensation coefficient for the beyond scheduled process period on the basis of the data selected with the variation pattern selection section 5. More specifically, the scheduled number of workers for the (M+1)^{th} week is calculated by the following Equation (6).
(The Scheduled Number of Workers for (M+1)^{th} Week)=(the Actual (Prediction) Number of Workers for Last Schedule Week)×(Compensation Coefficient) (6)

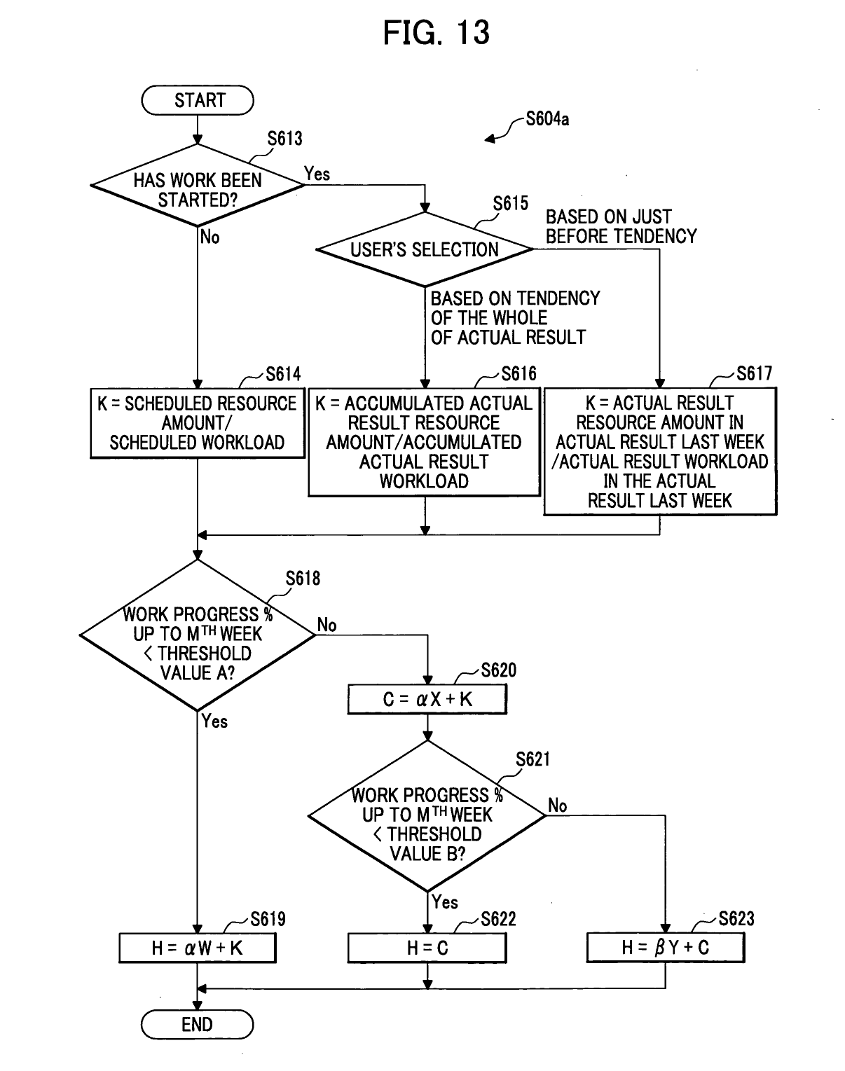

FIG. 13 shows a flow chart of a part S604a of the subroutine S604. In a judging step S613, it is judged whether the work subject to prediction has been started. To check this, there is a method of confirming whether the actual result data of the work is stored in the work actual result data storing section 2. If the work has not been started (No, in the judging step S613), processing proceeds to a processing step S614. If the work has been started (Yes, in the judging step S613), processing proceeds to a judging step S615. In the processing step S614, a value of a prediction working efficiency K as reference is calculated by the following Equation (7).
K=(Scheduled Resource Amount)/(Scheduled Workload) (7)

In the judging step S615, the user is required to select, as a method of calculating the value of the prediction working efficiency K to be reference, either one of methods of calculation with Equation (8) in a processing step S616 or the method of calculation by Equation (9) in a processing step S617. User's selection criteria is such that the processing step S616 is selected when the prediction working efficiency K is calculated on the basis of the tendency of the past actual results, and a processing step S617 is selected when it is calculated on the basis of the tendency just before.
K=(Accumulated Actual Result Resource Amount)/(Accumulation Actual Result Workload) (8)
K=(Actual Result Resource Amount for the Actual Result Last Week)/(Actual Result Workload for the Actual Result Last Week) (9)

In a judging step S618, it is judged whether the progress % of the work regarding the workload up to the M^{th} week is smaller than the threshold value A of the variation pattern selected by the variation pattern selection section 5. If the progress % of the work regarding the workload up to the M^{th} week is smaller than the threshold value A (Yes, in the judging step S618), processing proceeds to a processing step S619. If the progress % of the work regarding the workload up to the M^{th} week is not smaller than the threshold value (No, in the judging step 618), processing proceeds to a processing step S620. Here, the progress % of the work regarding the workload is calculated by Equation (10).
(Progress % of the Work)=[(Actual Result Workload (accumulation))+(Prediction Workload (accumulation))]/(Scheduled Workload (the whole))×100[%] (10)

In the processing step S619, a prediction working efficiency H defied as a prediction variation amount is calculated with a coefficient α of the variation pattern selected by the pattern selection section 5 and a value W represented with an integer indicating past weeks from the actual result last week (in the case that the work has been started) or the scheduled start week (in the case that the work is not started) with Equation (11).
H=αW+K (11)

In the processing step S620, a temporary variation C is calculated with Equation (12) using a value X representing in weeks the period from the actual result last week (in the case that the work has been started) or the scheduled start week (in the case that the work has not been started) to when the progress % of the work regarding the workload exceeds the threshold value A. This temporary variation C represents a value of the prediction working efficiency when the prediction working efficiency becomes a constant value.
C=αX+K (12)

In a judging step S621, it is judged whether the progress % of the work regarding the workload is smaller than the threshold value B of the variation pattern selected by the variation pattern selection section 5. If the progress % of the work regarding the workload is smaller than the threshold value B (Yes, in the judging step S621), processing proceeds to a processing step S622. If the work progress % of the work regarding the workload is not smaller than the threshold value B (No, in the judging step S621), processing proceeds to a processing step S623. In the processing step S622, the prediction working efficiency H is calculated by Equation (13).
H=C (13)

In the processing step S623, the prediction working efficiency H is calculated with the coefficient β of the variation pattern selected by the variation pattern selection section 5 and the number Y of weeks past from time when the work progress % of the work regarding the workload equal to or exceeds the threshold value B with the following Equation (14).
H=βY+C (14)

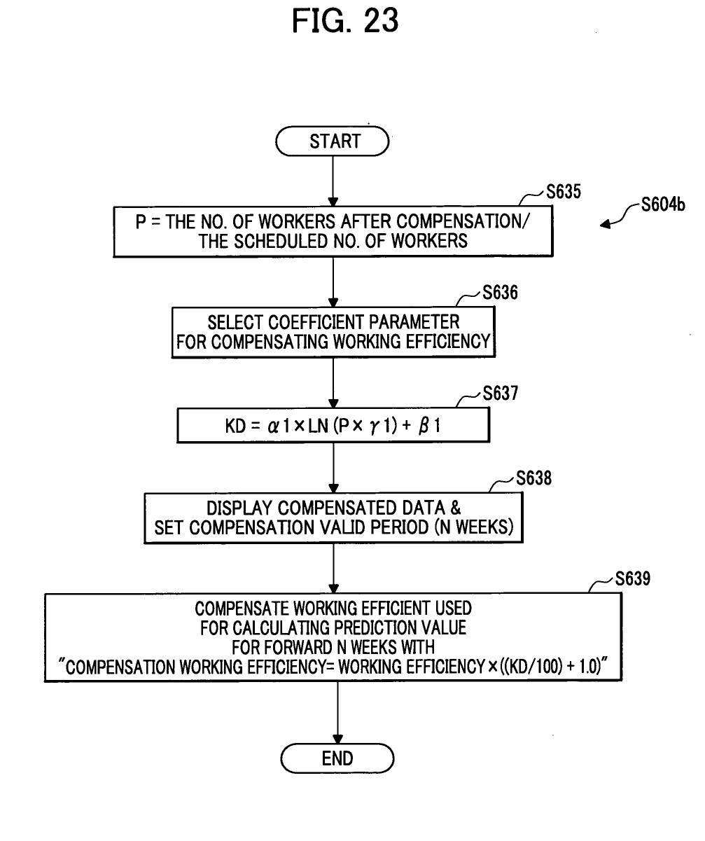

After the compensation of the working efficiency in the process, further, compensation for the working efficiency accompanied with the compensation of a scheduled resource amount is executed in accordance with the flow of another part S604b of the subroutine 604 as shown in FIG. 23. First, in a processing step S635, a variable P indicative of the ratio of the number of increased workers to the scheduled number of workers is calculated with the following Equation (15).
P=(the Number of Workers after Compensation)/(the Scheduled Number of Workers) (15)

Next, in a processing step S636, three coefficient parameters (coefficient α1 317, the coefficient β1 318, and the coefficient γ1 319) for compensation of the working efficiency are selected from the variation definition data storing section 3 on the basis of information of the variation characteristic code 316 of the work to be processed. In a processing step S637, with the selected coefficient parameters and the value of P, a decrease ratio (KD) of the working efficiency are calculated by Equation (1) previously described.

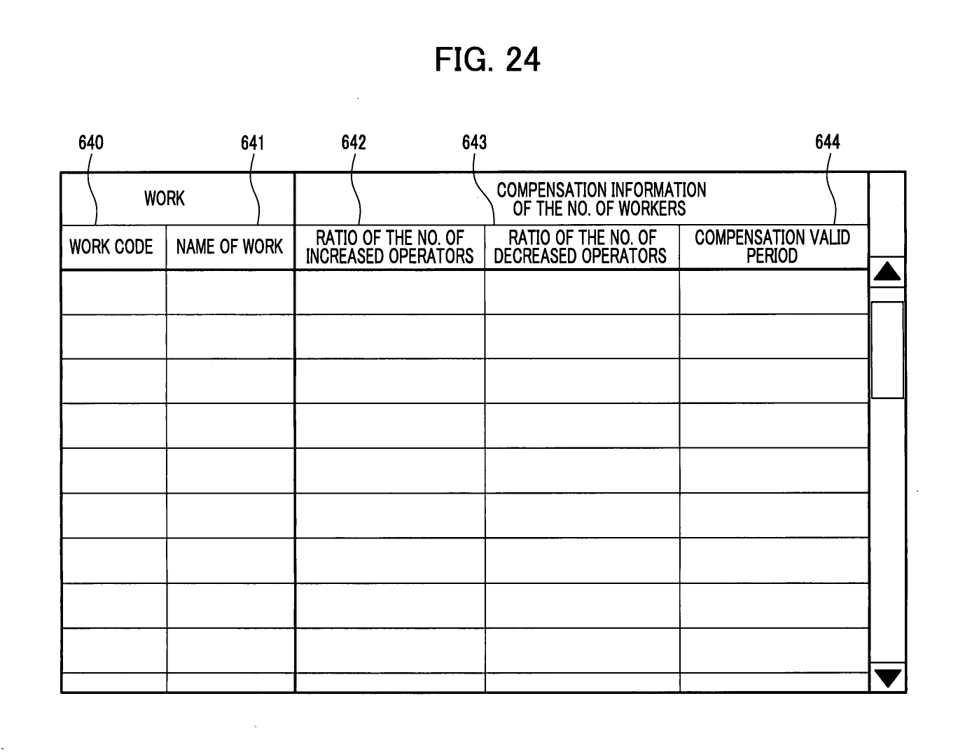

After that, in a processing step S638, values of P (the ratio of the number of increased workers) calculated as compensation data and KD (working efficiency decrease ratio) are displayed for confirmation by the user. FIG. 24 illustrates an example of the screen image for confirmation by the user. This screen image shows a name 641 of the work for each work code 640. Further, as information for compensating the number of workers, the ratio 642 of the number of increased workers and the working efficiency decrease ratio 643 are displayed. Here, the user confirms the values on the screen image. Regarding the working efficiency decrease ratio 643, the value can be modified in the interactive manner on the displayed screen image. Further, on the screen image, the compensation valid term 644 of the working efficiency decrease ratio 643 can be set in the interactive manner. In the case that improvement in decrease in the working efficiency is expected as time passes in such a case that the working efficiency decreases temporarily due to joining of non-skilled workers to increase the number of workers or the like, a period (term) limitation for the working efficiency decrease can be set with this input box. Further, if the compensation valid period 644 is not set, with assumption that the working efficiency continues to decrease, the following process is executed.

In a processing step S639, the prediction working efficiency used in the work status prediction is compensated by the following Equation (16) in consideration of the user's setting result in the processing step S638.
(Compensated Working efficiency)=(Working efficiency)×(((Working efficiency Decrease Ratio)/100)+1.0) (16)

In this operation, the compensation of the working efficiency using Equation (16) regarding the work, to which the period limitation regarding the working efficiency decrease is set in the processing step S638, can be executed only within the compensation valid period.

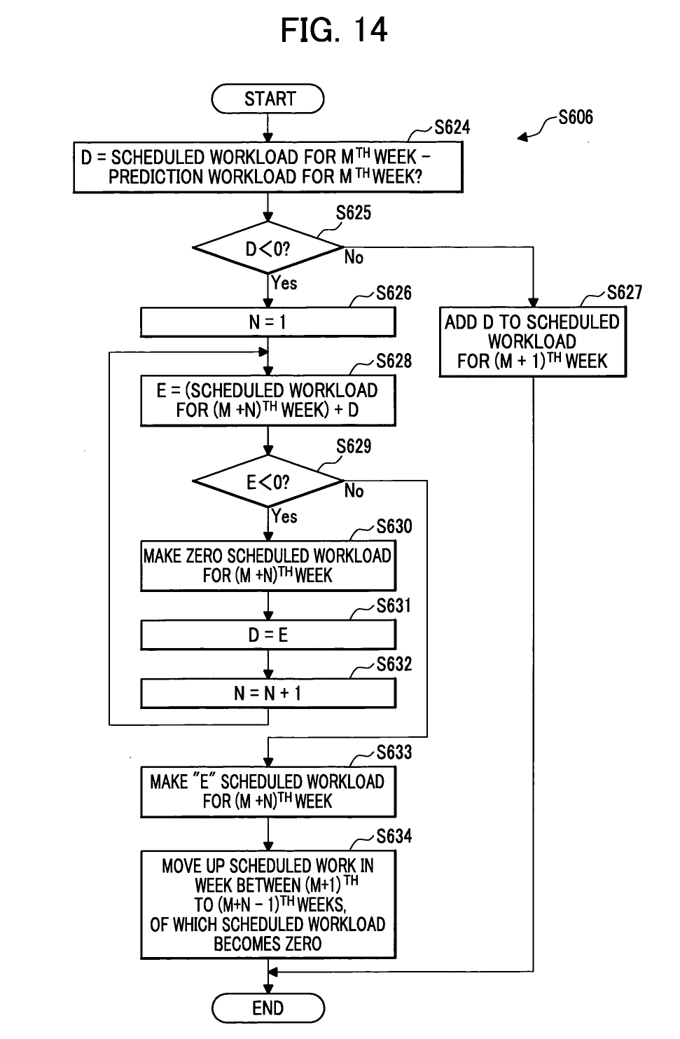

FIG. 14 shows a detailed flow chart of the subroutine step S606. In a processing step S624, a temporary variable D is calculated by the following Equation (17).
D=(Scheduled Workload for the M^{th} Week)−(Prediction Workload for the M^{th} Week) (17)

The variable M used in this equation is the same as that defined in FIG. 11. In a judging step S625, it is checked whether the value of D obtained in the processing step S624 is smaller than zero. If the value is smaller than zero (Yes, in the judging step S625), processing proceeds to a processing step S626. If the value is not smaller than zero (No, in the judging step S625), processing proceeds to a processing step S627.

In the processing step S627, the value of D is added to the scheduled workload for the (M+1)^{th} week. This is because when D has a positive value or a value of zero (No, in the judging step S625), the D indicates that there is a remaining prediction workload, so that the prediction remaining workload for the M^{th} week is transferred (carried over) to the next week. In a processing step S626, a temporary variable N is defined as one. In a processing step S628, a temporary variable E is calculated by the following Equation (18). In a processing step S628, a temporary variable E is calculated by the following Equation (18). This is because when D has a negative value (Yes, in the judging step S625), the D indicates that there is an unused workload, so that the unused workload for the M^{th} week is transferred to the next week to be spent.
E=(Scheduled Workload for the (M+N)^{th} Week)+D (18)

In a judging step S629, it is checked whether the value of E obtained in the processing step S628 is smaller than zero. If the value of E obtained in the processing step S628 is smaller than zero (Yes, in the judging step S629), processing proceeds to a processing step S630. If the value of E obtained in the processing step S628 is not smaller than zero (No, in the judging step S629), processing proceeds to a processing step S633. In the processing step S630, the scheduled workload for the (M+N)^{th} week is set to be zero. In a processing step S631, the value of D is updated by the following Equation (19). This is because the value of E is a negative value that indicates a used workload for the (M+N)^{th} week, so that the unused workload E is substituted for D to transfer it to the further next week to be used.
D=E (19)

In a processing step S632, one is added to the value of N, and processing returns to the processing step S628. In a processing step S633, the scheduled workload for the (M+N)^{th} week is set to be E. This is because when E has a positive or a value of zero, E indicates a remaining scheduled workload for the (M+N)^{th} week after the unused workload for the previous week was spent. In a processing step S634, the week having a scheduled workload of zero is cancelled in the whole of the schedule. More specifically, the final scheduled workload at each week is checked. If any week having the scheduled workload of zero exists between the (M+1)^{th} to the (M+N−1)^{th} week, the scheduled workload at the following week is successively moved up to the previous weeks. Thus, the scheduled work in the schedule is cancelled from the last week of the schedule. Here, in this embodiment, a variation in the working efficiency is represented by a first order equation. It is also possible to express the variation in a second order equation or a Weibull function.

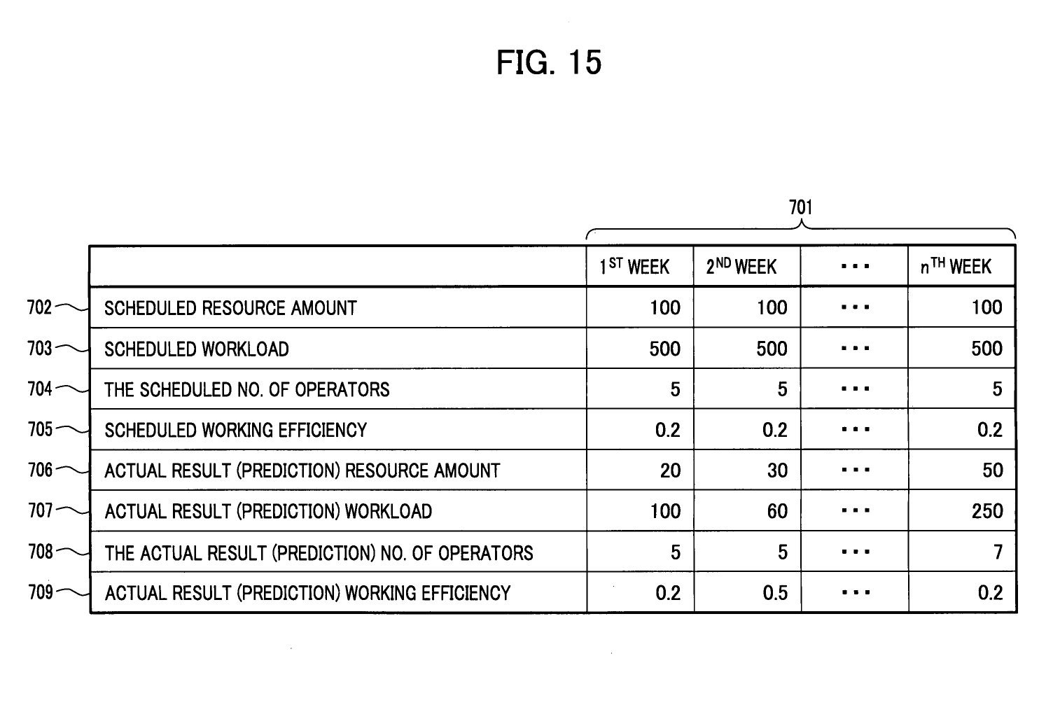

FIG. 15 shows an example of a data storing format in the prediction data storing section 7. The prediction data storing section 7 stores values of a scheduled resource amount 702, a scheduled workload 703, the scheduled number of workers 704, and a scheduled working efficiency 705. The prediction data storing section 7 further stores an actual result (prediction) resource amount 706, an actual result (prediction) workload 707, the actual result (prediction) number of workers 708, and an actual result (prediction) working efficiency 709, as data 701 for each week from the start week to the end week. The data is stored for each work. Further, “actual result (prediction)” means “actual result or prediction.” More specifically, the value of the past indicates that of “actual results” and the value of the future indicates that of “prediction.”

Example of Display of Prediction Result

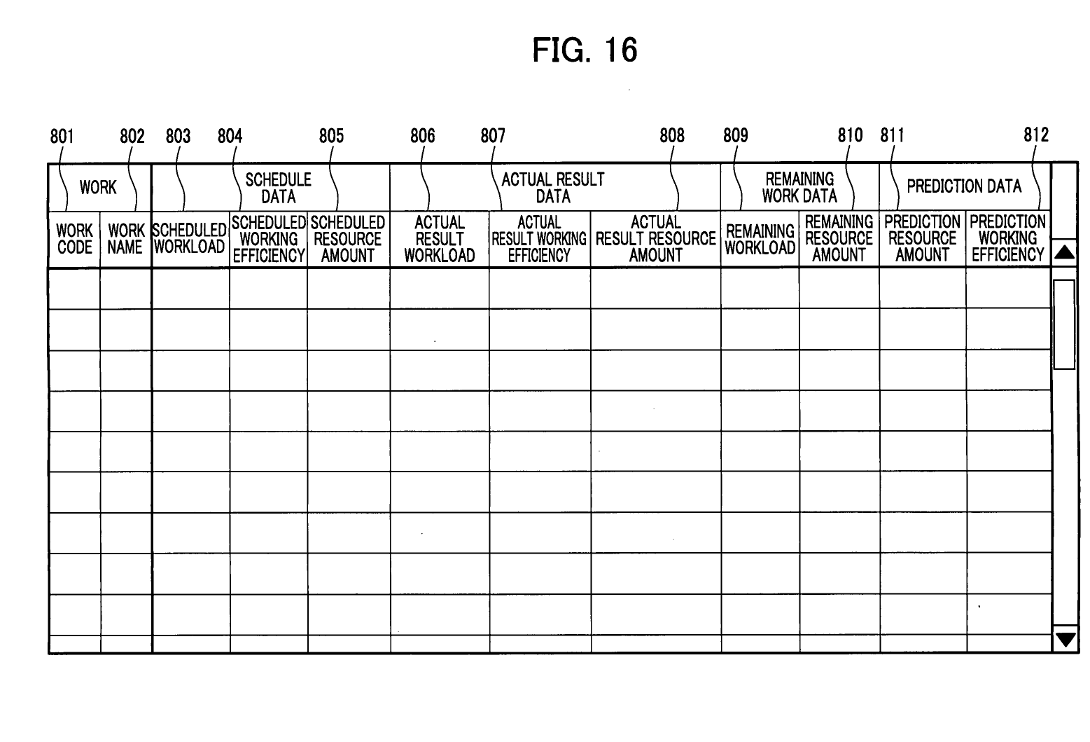

FIG. 16 shows an example of a screen image for displaying numerical data in a table. The screen image provides the numerical data of the following items for each work using the data in the work schedule data storing section 1, the data in the work actual result data storing section 2, and the data in the prediction data storing section 7. More specifically, the items include a work code 801, a work name 802, a scheduled workload 803, a scheduled working efficiency 804, calculated by (scheduled resource amount)/(scheduled workload), and a scheduled resource amount 805. The items further include an actual result workload 806 (accumulation value), an actual result working efficiency 807, calculated by (an accumulation value of the actual result resource amount)/(an accumulation value of actual workload), and an actual result resource amount 808 (accumulation value). The items further includes a remaining workload 809, calculated by (scheduled workload)−(actual workload), and a remaining resource amount 810, calculated by (scheduled resource amount)−(actual resource amount). The items further include a prediction resource amount 811, calculated by (actual result resource amount)+(the prediction resource amount up to the completion of the work), and a prediction working efficiency 812, calculated by (prediction resource amount)/(scheduled workload). Further, in addition to the information shown in FIG. 16, the information shown in FIG. 24 is also displayed. On the displayed screen image, if there is information set by the user in the interactive manner in the step S638 shown in FIG. 23, the setting information is also displayed.

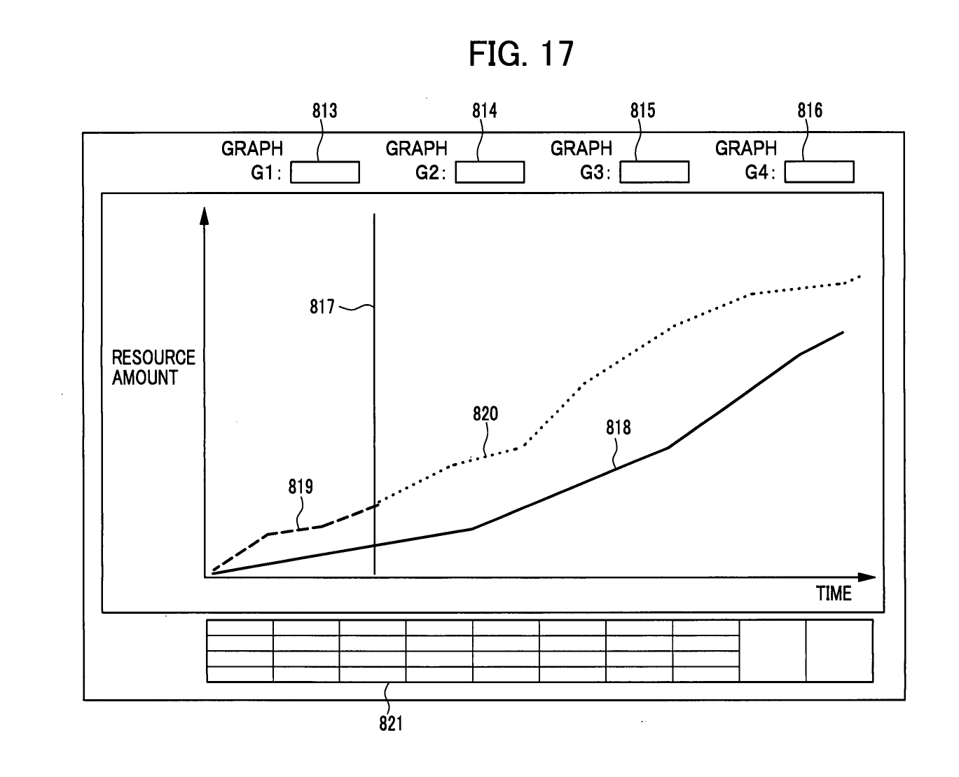

FIG. 17 shows an example of a displayed screen image provided by the prediction result display section 8. The user can optionally selects one of sets of the data represented by the references from 803 to 812 in gig. 16. In this operation, if the user desires to display the selected data on a graph curve G1, the user inputs into the input box 813 the code of the data which the user desired to display; on a graph curve G2, into the input box 814; and on a graph curve G3, into the input box 815; and on a graph curve G4, into the input box 816. Thus, the graph allows four curves to be displayed at the maximum with different types of lines such as a solid line and a chain line.

As an example of a graphical display result, a screen image displays a curve 818 representing variation in the scheduled resource amount, a curve 819 representing variation in the actual resource amount, and a curve 820 representing variation in the prediction resource amount. The screen image displays a line 817 representing the current week. Further, in step with the graph displaying, numerical data 821 for each week is displayed.

FIG. 18 shows an example of screen image which displays a detailed prediction result of works for each week. This screen image displays a simulation result of the work selected in the work code input box 822. The graph represents a status of each week in a time series manner, and the present time is indicated by a mark 823. The graph indicates data for each week such as a scheduled workload 824, an actual result workload 825, a transferred part 826 of an amount of delayed work up to the second week, a prediction work 827, a transferred part 828 of an amount of delayed work up to the third week, a transferred part 829 of an amount of delayed work up to the fourth week, and a transferred part 830 of an amount of delayed work beyond the schedule period with straight bars having different colors. The screen image displays a one-week backward button (icon) 831 and a one-week forward button (icon) 832 to provide one-week back and one-week forward display image to show the corresponding simulation result by the bar graph display at the desired week.

Process for Learning Variation Pattern

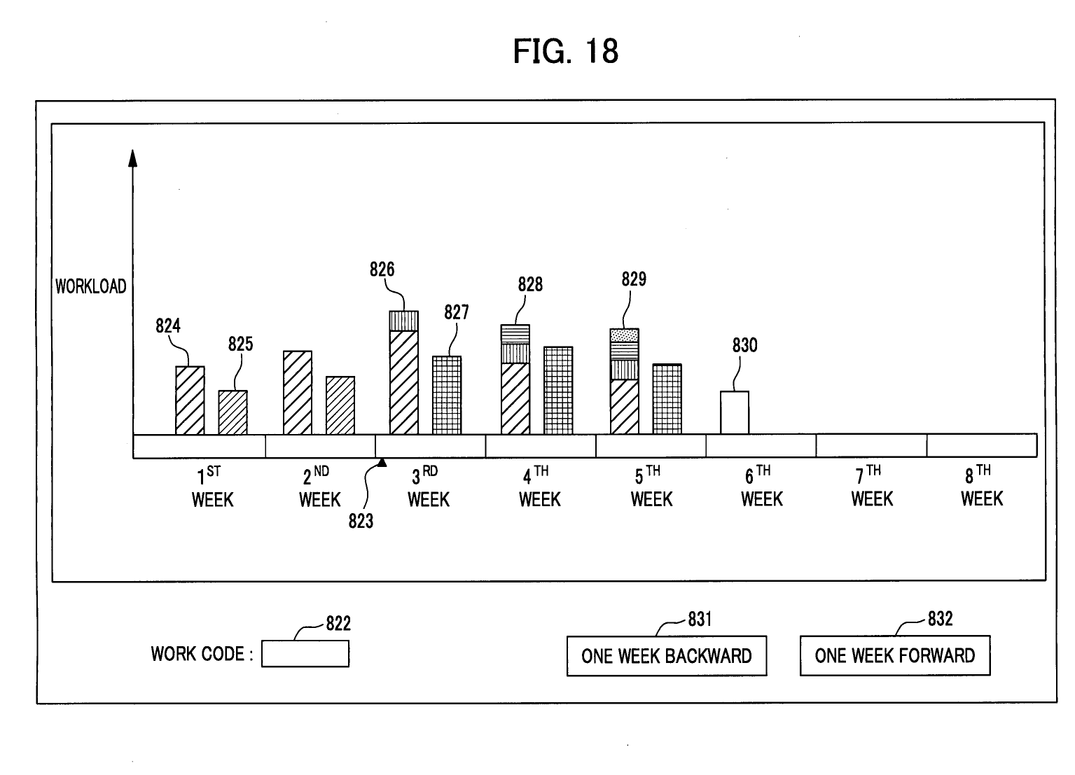

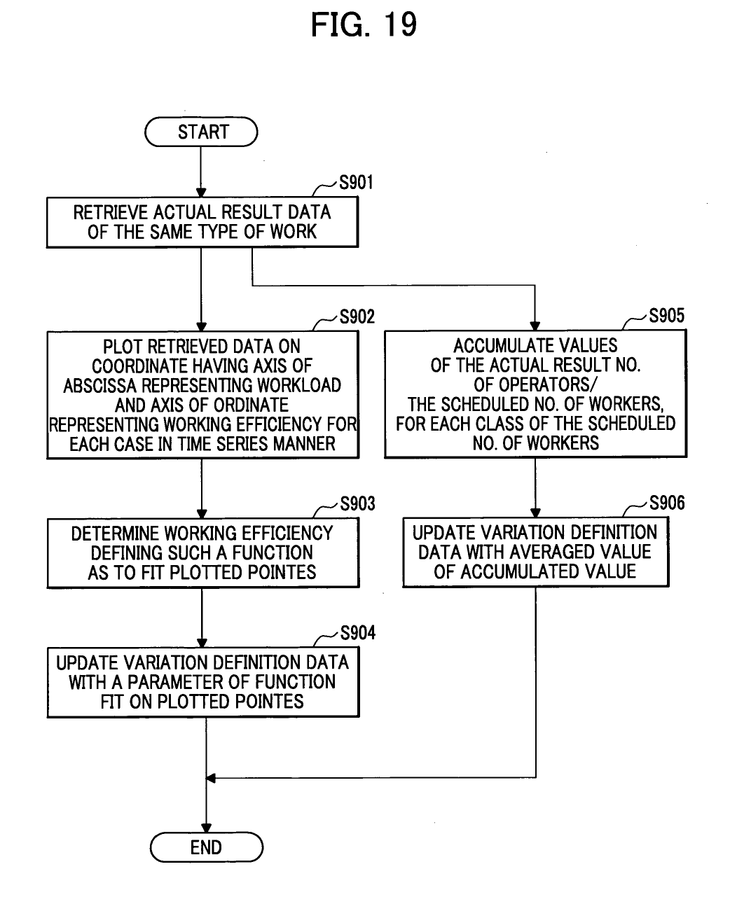

FIG. 19 shows a flow of a process for learning variation patterns. This process is executed by the variation pattern learning section 9. In a processing step S901, the actual result data of the work that is the same as the work to be learnt is retrieved from data stored in the work actual result data storing section 2. In a processing step S902, the retrieved data is plotted for each case on a graph having ordinates including an axis of abscissa representing the workload and an axis of ordinate representing the working efficiency. In a processing step S903, functions for defining such a working efficiency as to fit points plotted in the processing step S902 are obtained. For example, an algorithm including the method of least square is used. In a processing step S904, an update process for the variation definition data stored in the variation definition data storing section 3 is executed with coefficient parameters of the function subject to fitting.

On the other hand, in the processing step S905, values of compensation coefficients for the scheduled number of workers at each classification of the number of workers for each week (See FIG. 9) are calculated by the following Equation (20).
(Compensation Coefficient)=(the Actual Result Number of Workers)/(the Scheduled Number of Workers) (20)

In a processing step S906, the values of compensation coefficients calculated in the processing step S905 are averaged, and an updating process of the variation definition data stored in the variation defining data storing section 3 with the average value.

Here, the processing steps from S902 to S904 regarding the variation pattern learning and the processing steps from S905 and S906 are executed in parallel.

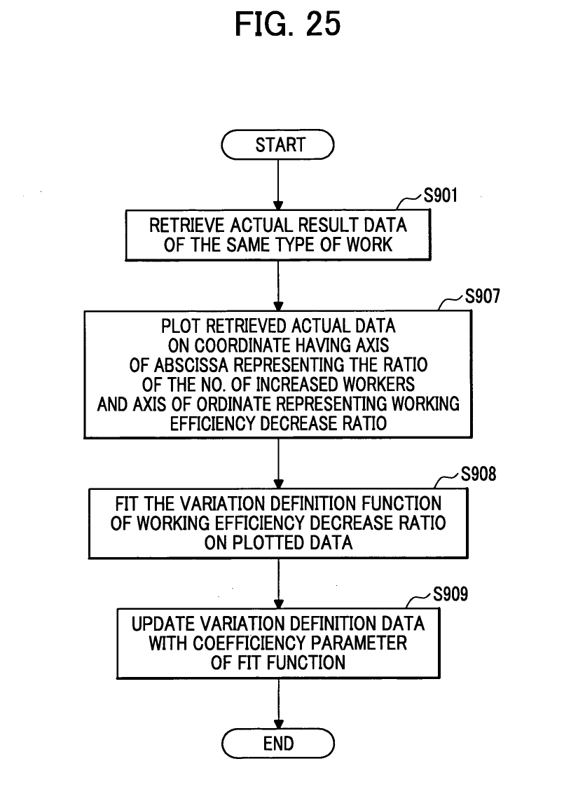

FIG. 25 shows a flow chart of learning parameters of variation patterns in the working efficiency accompanied with the compensating the scheduled resources amount. First, in a processing step 901, actual data of the work having the same type as the work to be learned is retrieved from the data stored in the work actual result data storing section 2. Next, in a processing step S907, the retrieved actual result data is plotted on a coordinate having an axis of abscissa representing a ratio of the number of increased workers and an axis of ordinate representing a decrease ratio of the working efficiency. In a processing step S908, parameters of a variation defining function of the working efficiency decrease ratio to the ratio of the number of increased workers are fitted on the plotted data. In a processing step S909, with the coefficient parameter of the fit function, an updating process is executed for the variation definition data stored in the variation definition data storing section 3.

Further, the processing steps regarding the learning the variation definition data of the working efficiency (Steps S902 to S904 in FIG. 9 and the processing steps regarding the learning of the number of increased workers (S905 and S906 in FIG. 19), and the processing steps regarding the learning of the variation pattern accompanied with the compensation of the scheduled resource amount (steps S907 to S909 in FIG. 25) are executed substantially in parallel.

As mentioned above, one example of the process according to an embodiment of the present invention has been described. In the actual processing, as shown in FIG. 20, in a hardware structure including a CPU (Central Processing Unit) Z01, a memory Z02, a storage unit Z03, an input device Z04, and an output unit Z05, the CPU Z01 transfers a schedule stored in the storage unit Z03 to the memory Z02 to executes the schedule on the basis of the command information inputted by the input unit Z04 to display the result on the output unit Z05.

### Other Embodiments

The preferred embodiment has been described according to the present invention with an example. However, the embodiment can be modified.

For example, in the embodiment, the schedule data, the actual result data, and the prediction data is stored in the storing section 7. However, it is also possible to store the schedule data in the work schedule data storing section 1. Further, the actual data can be stored in the work record data storing section 2 and the prediction data can be stored in the prediction data storing section 7. The prediction result display section 8 inputs each data from respective storing sections to use the data to display the prediction result.

Further, the work status prediction apparatus 20 can predict work status for a project including a plurality of sets of work in addition to a set of work. More specifically, the work includes a plurality of different types of substantially sequential processes, and the work status prediction section predicts the future work status of the sequential processes.

1. A work status prediction apparatus for predicting a future work status of work, comprising:
work schedule data storing means for storing work schedule data indicative of the work to be done for each future predetermine period, entered by a user such that a work schedule for each future predetermined period is stored as the work schedule data;
work actual result data storing means for storing work actual result data, indicative of the work that has been done for each past predetermined period, entered by the user such that a work actual result for each past predetermined period is stored as the work actual result data, the future predetermined period being equivalent to the past predetermined period;
work status prediction means for effecting prediction such that a prediction workload of the work for each future predetermined period is predicted from at least one of the work schedule and the work actual result and for predicting the future work status, in which the prediction amount of the future work is reflected in the work schedule data; and
prediction result display means of displaying the predicted result from the work status prediction means.

2. The work status prediction apparatus as claimed in claim 1, wherein the work schedule data includes a scheduled resource amount indicative of an amount of resource for the work scheduled for each future predetermined period and a scheduled workload indicative of an amount of the work scheduled for each future predetermined period, and the work actual result data includes an actual result workload indicative of an amount of the work that has been executed for each past predetermined period,
wherein the work status prediction means repeatedly executes a process until a total of an accumulation value of the actual result workload and an accumulation value of the prediction workload reaches a total of the scheduled workload, and
wherein in the process, the work status prediction means predicts working efficiency for each future predetermined period on the basis of either of the work schedule data or the work actual result data for the work,
calculates the prediction workload to be processed for each future predetermined period from the predicted working efficiency and the scheduled resource amount,
compares the calculated prediction workload with the scheduled workload,
when the prediction workload is not greater than the scheduled workload, carries over difference in a workload between the prediction workload and the scheduled workload to the next future predetermined period, and
when the prediction workload is greater than the scheduled workload, subtracts the difference from the scheduled workload of the next future predetermined period.

3. The work status prediction apparatus as claimed in claim 2, wherein the work status prediction means compensates at least one of the predicted working efficiency and the scheduled resource amount in accordance with progress of the work regarding the accumulation values of the actual result workload, the prediction workload, and the total of scheduled workload.

4. The work status prediction apparatus as claimed in claim 3, wherein actual result working efficiency is stored as the work actual result data such that the working efficiency is stored for each predetermined period in the work actual data storing means, and the work status prediction means provides, when the work actual result data for a plurality of the predetermined periods has been stored in the work actual result storing means, user's selection selectable for calculation of an initial working efficiency to be based on at start of the prediction effected by the work status prediction means from either of an accumulation value of the actual result efficiency over the whole of a plurality of the past predetermined periods for the work or the actual result efficiency in one of a plurality of the past predetermined periods for the work.

5. The work status prediction apparatus as claimed in claim 3, wherein the prediction result display means graphically displays as a prediction result at least one of the scheduled workload, the actual result workload, the prediction workload, a workload carried over to the next future predetermined period, and the difference.

6. The work status prediction apparatus as claimed in claim 3, further comprising interactive interface means for providing interactive interface with the user and variation pattern defining means for allowing the user to set a variation pattern of at least one of the predicted working efficiency and the scheduled resource amount in accordance with the progress of the work with the interactive interface means, wherein the work status prediction means compensates at least one of the predicted working efficiency and the scheduled resource amount in accordance with the variation pattern set by the user.

7. The work status prediction apparatus as claimed in claim 6, wherein when the user sets the variation pattern of the predicted working efficiency, the variation pattern defining means allows the user to set at least one of the scheduled workload and the scheduled resource amount for each future predetermined period.

8. The work status prediction apparatus as claimed in claim 7, wherein the work actual result data storing means further stores work actual data of past works, the work status prediction apparatus further comprising variation pattern learning means for retrieving the actual result data of the same type of the past works from the work actual result data storing means and calculating a coefficient parameter of a function defining variation of at least one of the working efficiency and the scheduled resource amount from the actual result data of the same type of the past works, and causing the variation pattern to reflect the calculated coefficient parameter.

9. The work status prediction apparatus as claimed in claim 6, wherein the work actual result data storing means further stores work actual data of past works, further comprising variation pattern learning means for retrieving the actual result data of the same type of the past works from the work actual result data storing means and calculating a coefficient parameter of a function defining variation of at least one of the working efficiency and the scheduled resource amount from the actual result data of the same type of the past works, and causing the variation pattern to reflect the calculated coefficient parameter.

10. The work status prediction apparatus as claimed in claim 3, wherein, when compensating the scheduled resource amount, the work status prediction means compensates the predicted working efficiency in accordance with a compensated amount of the scheduled resource amount.

11. The work status prediction apparatus as claimed in claim 10, wherein the work status prediction means limits, to a predetermined term, that the work status prediction means compensates the predicted working efficiency in accordance with a compensated amount of the scheduled resource amount.

12. The work status prediction apparatus as claimed in claim 11, further comprising interactive interface means for providing interactive interface with the user and means for allowing the user to set a variation pattern of an amount of compensation of the predicted working efficiency in accordance with an amount of compensation of the scheduled resource amount using the interactive interface means.

13. The work status prediction apparatus as claimed in claim 10, further comprising interactive interface means for providing interactive interface with the user and means for allowing the user to set a variation pattern of an amount of compensation of the predicted working efficiency in accordance with an amount of compensation of the scheduled resource amount using the interactive interface means.

14. The work status prediction apparatus as claimed in claim 1, wherein said work includes a plurality of different types of substantially sequential processes, and the work status prediction means predicts the future work status of the processes.

15. A method of predicting a future work status of work in a computer-base apparatus, comprising the steps of:
(a) calculating a working efficiency for a future predetermined period from either of a scheduled resource amount indicative of an amount of resource of the work for the future predetermined period and the scheduled workload indicative of an amount of the work to be done for the future predetermined period or the actual result resource amount indicative of an amount of actual result resource for the work for past predetermined period and the actual result workload indicative of an amount of the work processed for the past predetermined period;
(b) compensating the calculated working efficiency and the scheduled resource amount for the future predetermined period in accordance with progress of the work in a current predetermined period;
(c) calculating a prediction workload indicative of an amount of the work expected for the future predetermined period from the compensated working efficiency and the scheduled resource amount;
(d) when the prediction workload is not greater than the scheduled workload, carrying over the difference between the prediction workload and the scheduled workload to the scheduled workload of the next period,
(e) when the prediction workload is greater than the scheduled workload, subtracting the difference from the scheduled workload for the next future predetermined period; and
(f) repeatedly executing the steps (a) to (e) until a total of an accumulation value of the actual result workload and an accumulation value of the prediction workload reaches a total of the scheduled workload.

16. The method as claimed in claim 15, wherein in step (b), when the scheduled resource amount is compensated, the working efficiency is also compensated in accordance with a compensated amount of the scheduled resource amount.

17. The method as claimed in claim 16, further comprising the step of limiting, to a predetermined term, that the work status prediction means compensates the working efficiency in accordance with a compensated amount of the scheduled resource amount.

18. The method as claimed in claim 17, further comprising the step of allowing, when the working efficiency is compensated in accordance with a compensated amount of the scheduled resource amount, the user to set a variation pattern of a compensated amount of the working efficiency in accordance with an amount of compensation of the scheduled resource amount through interactive interface with the user, wherein the working efficiency is compensated in accordance with the set variation pattern.

19. The method as claimed in claim 16, further comprising the step of allowing, when the working efficiency is compensated in accordance with a compensated amount of the scheduled resource amount, the user to set a variation pattern of a compensated amount of the working efficiency in accordance with an amount of compensation of the scheduled resource amount through interactive interface with the user, wherein the working efficiency is compensated in accordance with the set variation pattern.

20. A work status prediction program for predicting a future work status of work to make a computer execute the processes for:
(a) calculating a working efficiency for a future predetermined period from either of a scheduled resource amount indicative of an amount of resource of the work for the future predetermined period and the scheduled workload indicative of an amount of the work to be processed for the future predetermined period or the actual result resource amount indicative of an amount of actual result resource for the work for past predetermined period and the actual result workload indicative of an amount of the work processed for the past predetermined period;
(b) compensating the calculated working efficiency and the scheduled resource amount for the future predetermined period in accordance with progress of the work in the predetermined period;
(c) calculating a prediction workload indicative of an amount of the work expected for the future predetermined period from the compensated working efficiency and the scheduled resource amount;
(d) when the prediction workload is not greater than the scheduled workload, carrying over the difference between the prediction workload and the scheduled workload to the scheduled workload of the next period,
(e) when the prediction workload is greater than the scheduled workload, subtracting the difference from the scheduled workload for the next future predetermined period; and
(f) repeatedly executing the steps (a) to (e) until a total of an accumulation value of the actual result workload and an accumulation value of the prediction workload reaches a total of the scheduled workload.

21. The program as claimed in claim 20, wherein in the process (b), when the scheduled resource amount is compensated, the working efficiency is also compensated in accordance with a compensated amount of the scheduled resource amount.

22. The program as claimed in claim 21, further comprising a process for limiting, to a predetermined term, that the work status prediction means compensates the working efficiency in accordance with a compensated amount of the scheduled resource amount.

23. The program as claimed in claim 22, further comprising a process for allowing, when the working efficiency is compensated in accordance with a compensated amount of the scheduled resource amount, the user to set a variation pattern of a compensated amount of the working efficiency in accordance with an amount of compensation of the scheduled resource amount through interactive interface with the user, wherein the working efficiency is further compensated in accordance with the set variation pattern.

24. The program as claimed in claim 21, further comprising a process for allowing, when the working efficiency is compensated in accordance with a compensated amount of the scheduled resource amount, the user to set a variation pattern of a compensated amount of the working efficiency in accordance with an amount of compensation of the scheduled resource amount through interactive interface with the user, wherein the working efficiency is further compensated in accordance with the set variation pattern.
